(19) United States
(12) Patent Application Publication
(10) Pub. No.: US 2014/0029394 A1
(43) Pub. Date: Jan. 30, 2014

(54) TIMEPIECE COMPRISING REMOVABLE ACCESSORIES, AND METHOD FOR MOUNTING/REMOVING SAID ACCESSORIES

(71) Applicant: Paul HARTZBAND, Brookfield, CT (US)

(72) Inventor: Anthony Saunier, Porrentruy (CH)

(21) Appl. No.: 14/111,453

(22) PCT Filed: Oct. 14, 2011
(86) PCT No.: PCT/EP2011/067956

§ 371 Date: Oct. 11, 2013

(30) Foreign Application Priority Data
Apr. 14, 2011 (CH) CH00667/11

(51) Int. Cl. G04B 47/04

(52) U.S. Cl. CPC G04B 47/046
USPC 368/285; 29/896.33

(57) ABSTRACT

A timepiece includes a first and at least one second removable accessory, a locking system that is activated to rigidly connect the accessories to the timepiece and deactivated to detach the accessories from the timepiece, the locking system including a locking member that is movable between an operative position and an inoperative position for locking and unlocking the first accessory, respectively, a safety element which is automatically activated upon the unlocking of the first accessory, and which prevents the complete removal of the first accessory from the timepiece, and a blocking member for preventing the separation of at least one second accessory from the timepiece, the blocking member consisting of a functional portion of the first accessory.

### TECHNICAL FIELD

The present invention relates to the technical field of horology. The invention more particularly relates to the removal and replacement of accessories on a timepiece. Such a timepiece may be equipped with a locking system to secure at least one accessory to said timepiece. Such a system also makes it possible to separate an interchangeable accessory from the timepiece and replace that accessory for repair or aesthetic purposes.

A timepiece including a locking system according to the invention must be understood broadly and relates to various objects or devices such as a bracelet watch, a miniature clock, a clock, a jewel, a pendant, a brooch, a bracelet or any other assembly of an aesthetic and functional nature related to horology.

### BACKGROUND OF THE INVENTION

Timepieces are generally chosen or assessed based on their aesthetic quality. It is therefore natural to wish to improve their aesthetic appearance when possible. To that end, it is possible to consider using removable and interchangeable accessories.

Typically, the term “accessory” defines external elements of the timepiece, contributing to the general appearance of that timepiece but without being involved in the specific horology function. This may thus be part of the box, such as a bezel or a cap. It may also be a fastening element, such as a bracelet or a chain for a watch or pendant, or a base or support for a miniature clock.

It is known, for example from document CH 698652, to produce a bracelet fastening device for watches, including a rotating ring. The latter is provided with a tongue engaging in the end of the bracelet so as to lock said bracelet on part of the watch middle having a counter-form of said bracelet end.

Such a system requires a certain skill to be manipulated, since it is necessary to hold the watch and the bracelet and actuate the rotating ring simultaneously. Furthermore, once the unlocking is done, the bracelet is free to separate from the watch. There is therefore a risk of the bracelet detaching in an untimely manner.

Also known from document CH 697144 is a watch provided with a locking system for fastening a cap and a bracelet on a case. The locking system comprises a locking arm actuated when the watch is positioned in an ad hoc bed of a presentation case. The locking arm is mounted on the case pivotably and passing through a cutout formed in the end of the bracelet. This locking arm next snaps onto a peripheral edge of the cap to secure the bracelet and the cap to the case simultaneously.

Such an embodiment simplifies handling during the separating operation of the bracelet and the bezel, since the watch is placed in its presentation-case. However, the removal is difficult without that presentation-case, which is not very practical. Furthermore, once the locking system is placed in the unlocked position, both the bracelet and the cap are freed at the same time, which is not optimal in terms of the operating or handling safety.

These different embodiments of the state of the art have the drawback that the bracelets and/or the cap may separate from the case very easily and involuntarily or accidentally during unlocking. This is very disadvantageous, in particular when the locking makes it possible to retain several accessories.

### BRIEF DESCRIPTION OF THE INVENTION

The present invention aims to offset the aforementioned drawbacks and propose a new method for removing removable accessories from a timepiece.

The present invention also aims to provide a timepiece including a new locking system ensuring locking of several removable accessories on said timepiece.

The invention also aims to provide a timepiece including a system for locking removable accessories having increased operating safety in particular during removal of said accessories.

The aims sought by the invention are achieved owing to a method for removing removable accessories from a timepiece equipped with a locking organ, as defined in the claims.

The invention also relates to a timepiece as defined in the claims.

### BRIEF DESCRIPTION OF THE DRAWINGS

Other features of the present invention will appear more clearly upon reading the following description, done in reference to the appended drawing, provided as an non-limiting example, in which:

FIG. 1 shows an example embodiment in top view of a timepiece according to the invention,

FIGS. 2 and 3 show a partial cross-sectional view of one example embodiment of a timepiece according to the invention including a locking system, in a locked state and an unlocked state, respectively,

FIGS. 2 to 7 show partial cross-sectional views of an example embodiment of a timepiece according to the invention, similar to FIG. 1, said views showing successive states and positions of the method according to the invention,

FIG. 8 shows a half cross-sectional view OA of the example of the timepiece of FIG. 1,

FIG. 9 illustrates a half cross-sectional view OB of the example of the timepiece of FIG. 1,

FIG. 10 illustrates a top external view of another example embodiment of a timepiece according to the invention,

FIG. 11 illustrates a partial cross-sectional view along the axis of rotation of a locking system control crown of the timepiece of FIG. 10,

FIG. 12 shows a partial cross-sectional view OD of the timepiece of FIG. 10, and

FIGS. 13 to 19 show different cross-sectional top views of embodiments of a locking organ for a timepiece according to the invention.

### DETAILED DESCRIPTION OF THE INVENTION

Structurally and functionally identical elements present in several figures are assigned a same numeric or alphanumeric reference.

The present description refers more particularly to a timepiece formed by a watch, but is in no way limited to this particular example application.

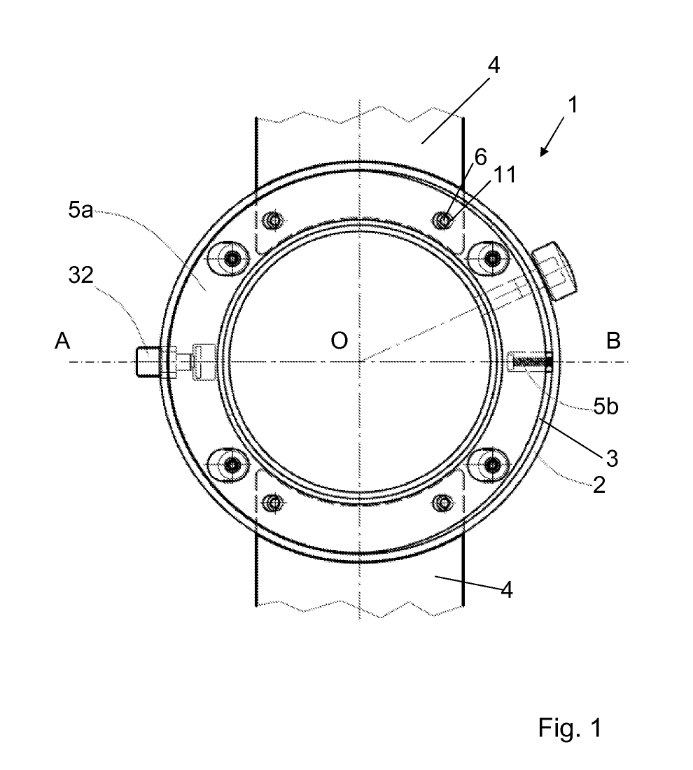

FIG. 1 shows a timepiece 1 including a movement 16, not shown in this figure, and housed in a case 2. This movement 16 includes a control arbor 30 provided for setting the time and, optionally, for winding if the movement 16 is mechanical.

The timepiece 1 is equipped with a first accessory 3, typically assuming the form of a bezel. It is also equipped with second and third accessories 4, in the proposed example, each assuming the form of a bracelet strand, assembled on the case 2. As will be understood hereafter, the accessories 3 and 4 are removably mounted on the timepiece 1. The latter further comprises a locking system activated to secure the accessories 3, 4 on the timepiece 1 and deactivated to allow the removal of said accessories 3, 4 from the timepiece 1.

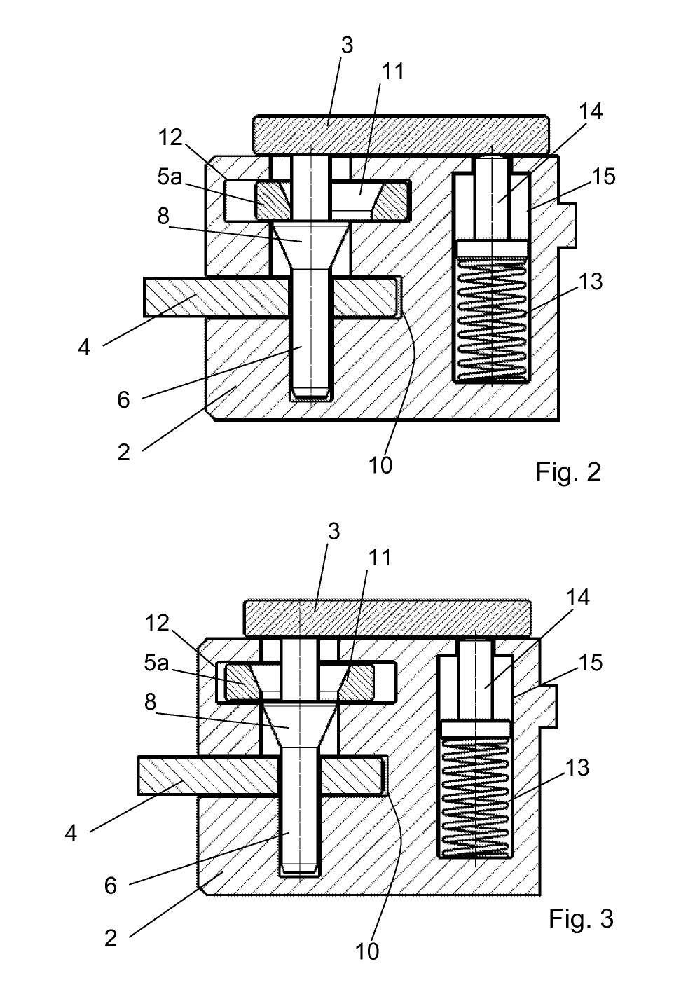

As shown more particularly in FIGS. 2 to 7, the first accessory 3 includes a functional part arranged to cooperate with the second accessory 4 to secure it and lock it to the timepiece 1. More particularly, the bezel comprises an arbor 6 extending orthogonally relative to the extension plane of the bezel. Furthermore, each bracelet strand is dimensioned so as to be able to be adjusted in a bed 10 of the case 2, provided to that end. Each bracelet strand also includes an opening 9, positioned such that the arbor 6 passes through it when the accessories are in the functional position. Preferably, the opening 9 is dimensioned such that the second accessory 4 is maintained without play when the arbor 6 passes through it. The sections of the arbor 6 and the opening 9 therefore have similar dimensions.

The functional part of the first accessory 3, i.e., in the proposed example, the arbor 6 of the bezel, is arranged to cooperate with a locking organ, which is part of the locking system. To that end, the arbor 6 includes a collar 8, the section of which has a dimension larger than the arbor 6 and which thus defines a rim.

The locking organ advantageously assumes the form of a rigid and annular clamp 5a, completely visible in FIG. 1. In this example, the clamp 5a is translatably mounted in a locking bed 12, which extends substantially on the periphery of the timepiece 1, around the movement 16. The locking organ is movable between an active position and an inactive position to respectively lock and unlock the first accessory 3. A complementary elastic organ 5b is arranged to exert a return force on the clamp 5a, tending to keep it in the active position. As will be described hereafter, a manual control device is arranged on the case 2 to move the locking organ. The locking system is thus made up of the locking organ, the complementary elastic organ 5b and the manual control device.

The clamp 5a is provided with at least one window 11 for the passage of the functional part. Preferably, for better stability and better guiding of the first accessory 3, the latter includes several functional parts and the locking organ cooperates with each of them through an equal number of windows 11.

Each window 11 is dimensioned so as to define a banking with which the collar 8 can cooperate when the locking system is activated, so as to allow the free passage of the collar 8 when the locking system is deactivated.

Preferably, the windows 11 each have two areas with different dimensions and able to position themselves across from the corresponding collar 8, during the movement of the clamp 5a from one position to the other. One of the areas having the smallest dimensions is dimensioned so as to block the passage of the collar 8 when the locking organ is in the active position, whereas the other area, having larger dimensions, allows the passage of the collar 8 when the locking organ is in the inactive position.

FIGS. 2 to 7 additionally show that the timepiece 1 has automatic expulsion means arranged so as to exert a force on the first accessory 3 tending to remove it from said timepiece 1.

The automatic expulsion means comprise at least one elastic organ 13 such as a spring, pre-stressed to exert a force on the first accessory 3 in its removal direction. Such a spring is advantageously associated with a piston 14, thus forming a subassembly mounted in an additional bed 15 of the case 2. As long as the first accessory 3 is locked on the timepiece, the elastic organ 13 is not effective. Once the locking system is deactivated, the elastic organ 13 pushes the first accessory 3 in a removal direction tending to separate it from the timepiece 1.

The additional bed 15 includes a banking that forms an organ limiting the travel of the automatic expulsion means, which thus defines an intermediate removal position, shown in FIG. 5, in which:
the position of the first accessory 3 is stabilized by safety means,
the first accessory 3 may be grasped manually to be completely removed,
the second accessory 4 is kept secured to the timepiece 1 by the first accessory 3.

Indeed, in this position, the locking organ, in this case the clamp 5a, exerts friction on the functional part, in this case the arbor 6, under the action of the complementary elastic organ 5b, which exerts a braking force opposing the complete removal of the first accessory 3. The clamp 5a is pressed below the collar 8, in reference to the removal direction. In other words, the collar 8 no longer abuts against the clamp 5a. It will be understood that the securing means begin to work and the braking is exerted automatically once the user has released the manual control device. Thus, the complementary elastic organ 5b participates both in the locking of the first accessory 3 and the safety means.

When the first accessory 3 is in the intermediate removal position, it is positioned protruding relative to the timepiece 1. A user may therefore grasp it. Given that, in this position, the locking organ only produces braking, but no longer any blocking, the user may grasp the first accessory 3 and remove it completely by exerting a pulling force greater than the braking forces.

It will be noted that advantageously, the arbor 6 is always engaged in the opening 9 when the first accessory 3 is in the intermediate removal position. Thus, owing to the braking exerted by the locking organ, both the first and second accessories 4 are always secured to the timepiece 1, even if they are no longer locked. The risk of losing the accessories during accidental actuating of the manual control device is therefore limited. Furthermore, during deliberate actuation of said device, the passage through the intermediate removal position ensures complete oversight of the operations and prevents loss of any of the accessories.

It will be noted that although in this example, the braking and locking are exerted on the arbors 6, it is possible to consider having the locking organ cooperate with different functional parts, to perform the locking and braking functions, respectively.

Thus, in FIG. 2, the locking system and the locking organ are in the active position. The bezel is mounted on the timepiece 1 and the locking organ locks the bezel by cooperating with the collar 8. Through this locking and the engagement of the arbor 6 in the opening 9, the bracelet is also secured and locked to the timepiece 1.

The complementary elastic organ 5b exerts a return force on the clamp 5a, tending to keep it in the active position and maintaining the locking.

In FIG. 3, the locking system is deactivated. A user has actuated the manual control device to move the locking organ by stressing the complementary elastic organ. The position shown in this FIG. 3 is very fleeting, since the automatic expulsion means promptly exert their action to bring the first accessory 3 into its intermediate removal position.

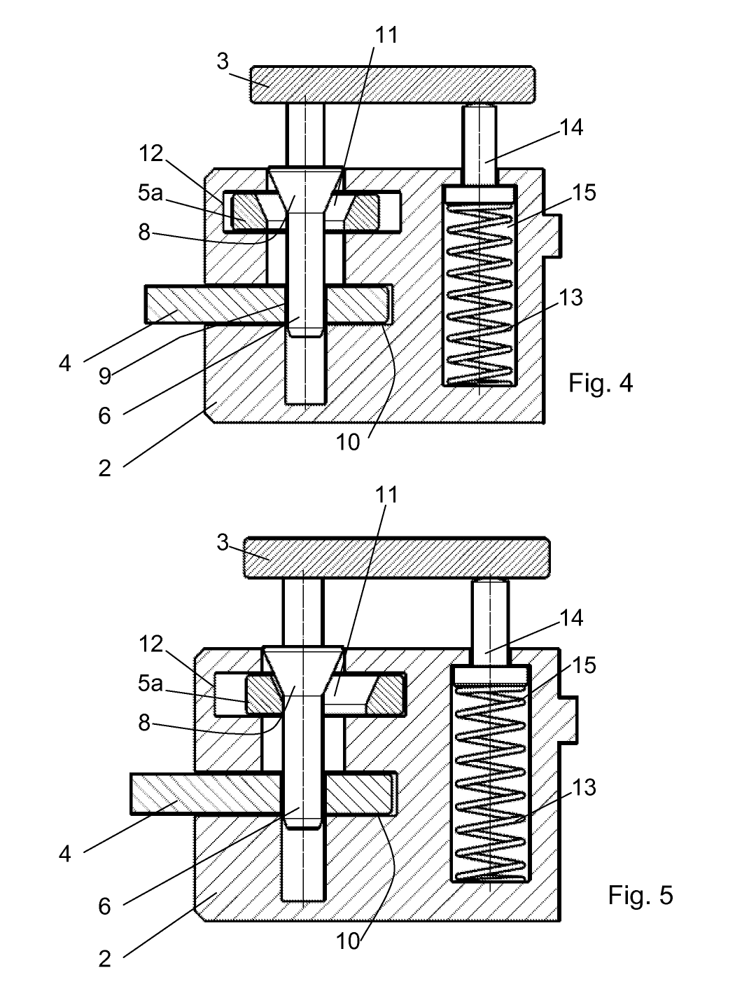

When the user has not yet released the manual control device, the locking system is as illustrated in FIG. 4, i.e., the clamp 5a does not yet exert a braking force on the arbor.

When the user has released the manual control device, the locking system is then only subjected to the force from the complementary elastic organ 5b. This then creates the situation of FIG. 5, and the first accessory 3 is in its intermediate removed position.

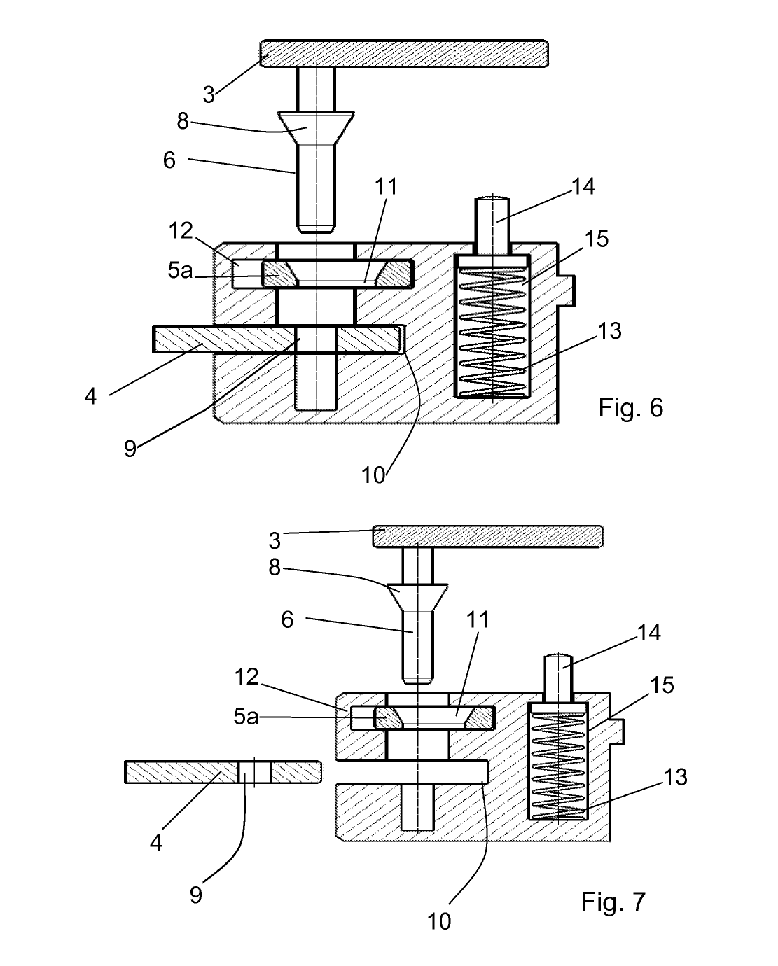

The user can then grasp the first accessory 3 and remove it completely, i.e., separate it from the timepiece 1 (FIG. 6). The clamp 5a is then placed abutting in its locking bed 12. The second accessory 4 and the other additional accessories, in this case the two strands of the bracelet, are then separated from the timepiece 1 (FIG. 7).

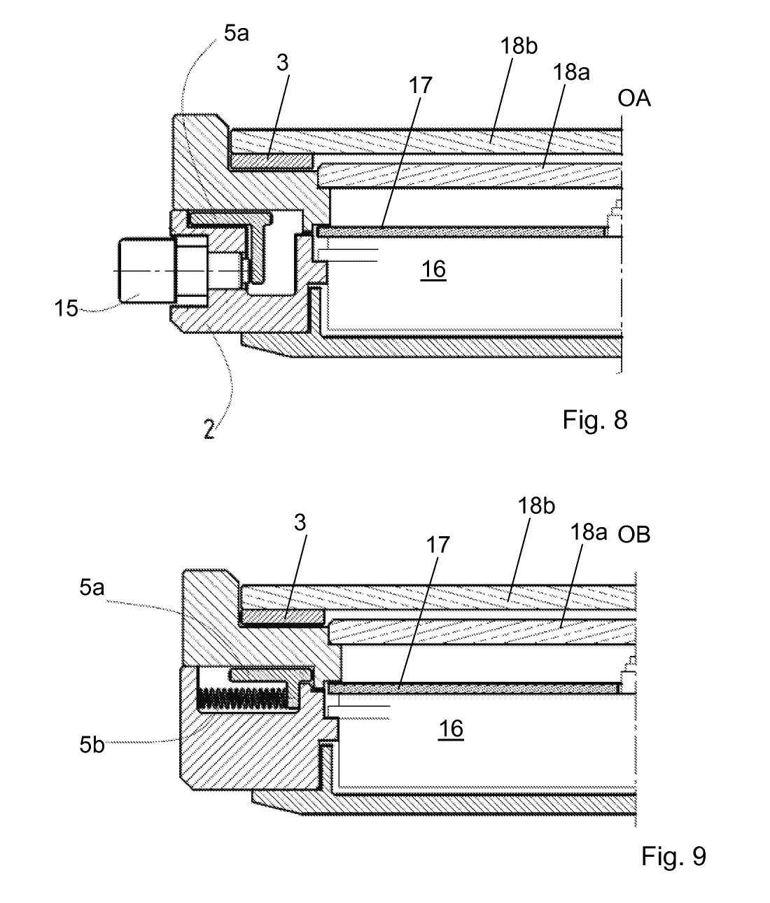

FIGS. 8 and 9 are detailed views of the timepiece 1 of FIG. 1. FIG. 8 is a half cross-sectional view along axis OA. The manual control device is a pushbutton 32. It makes it possible to move the locking organ by translation in the plane of the case 2, along a radial direction. The pushbutton 32 cooperates with a leaf of the clamp 5a, situated in the travel of the pushbutton.

These figures in particular show the movement 16, which is topped by a dial 17. Conventionally, a glass 18a is fixed to the middle and protects the dial 17 and the hands. Thus, even when the bezel is removed, the dial, the hands and the movement 16 remain protected. Nevertheless, in order for the bezel not to appear raised relative to the glass, which is not esthetically desirable, the bezel 4 is secured to a second glass 18b, which closes the timepiece 1, substantially in its middle, or an optional flange.

FIG. 9 is a half cross-sectional view OB of the timepiece 1 of FIG. 1. This figure more particularly illustrates the complementary elastic organ 5b, in this case formed by a spring, and its action on the locking organ.

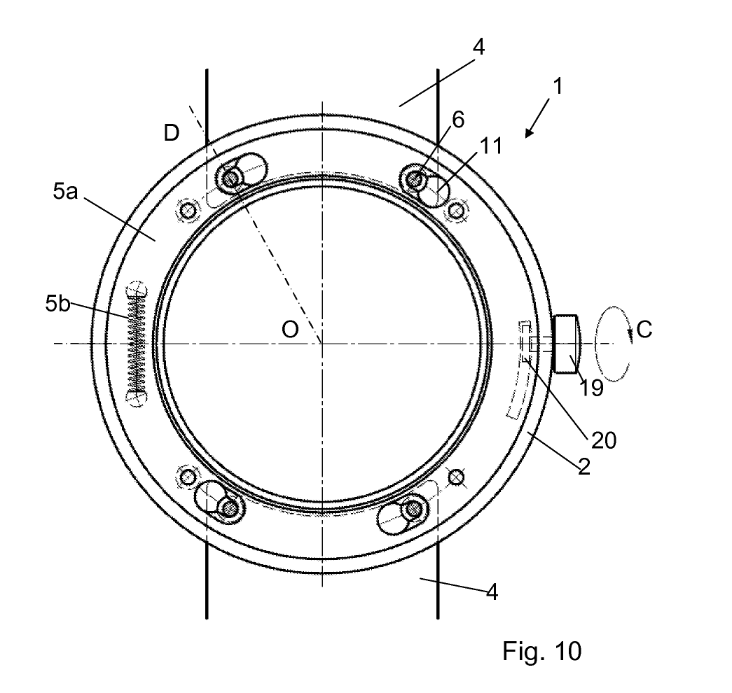

FIG. 10 proposes another embodiment of the invention, in which the locking organ is rotatably mounted in the locking bed 12. It is actuated by a manual control device assuming the form of a crown 19 capable of being rotated.

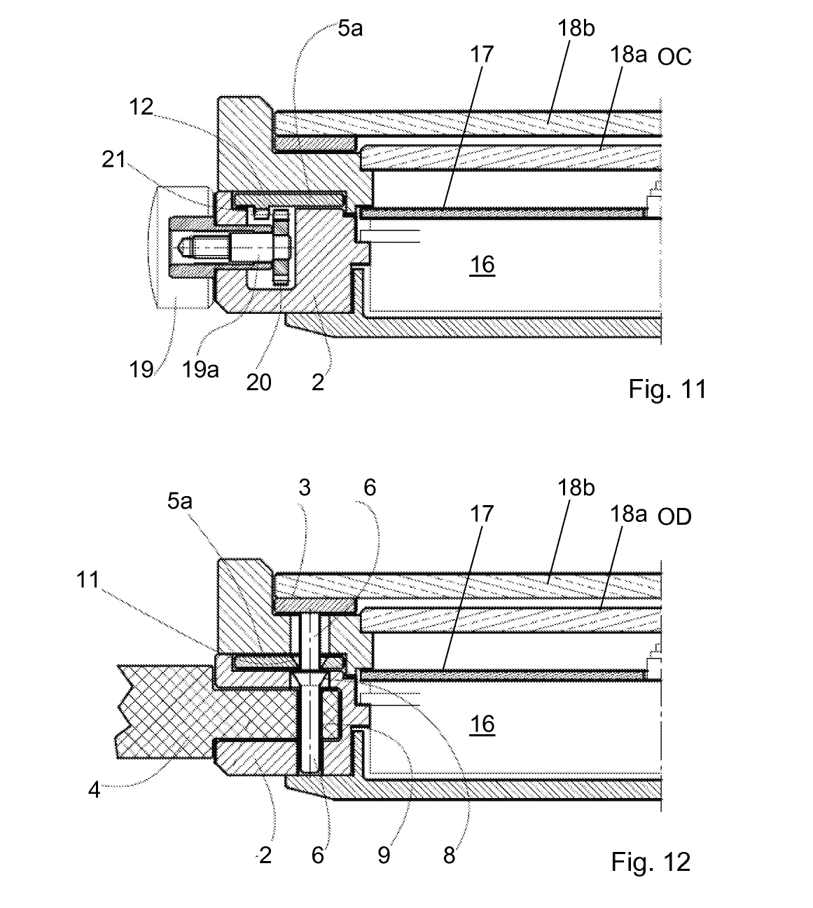

FIG. 11 is a partial cross-sectional view OC along the axis of rotation of the crown 19 of the locking system of the timepiece 1 of FIG. 10. The crown 19 may be moved axially to engage a meshing pinion 20 with a toothing 21 forming a rack section of the locking organ. The meshing pinion 20 is secured to the crown 19 by a cylindrical arbor 19a, so as to rotate the locking organ for example to go from an active position illustrated in FIG. 12 to an inactive position. FIG. 11 shows the control crown 19 in a neutral position inasmuch as the meshing pinion 20 is in a non-meshed position. Accidentally actuating the control crown 19 therefore has no effect on the locking organ, as long as said control crown 19 is not moved axially to mesh the meshing pinion 20 with the toothing 21.

FIG. 12 is a partial cross-sectional view OD along an axis passing through a functional part, in this case an arbor 6, of a first accessory 3 and through a second accessory 4 of the timepiece 1 of FIG. 10. It illustrates the activated locking system.

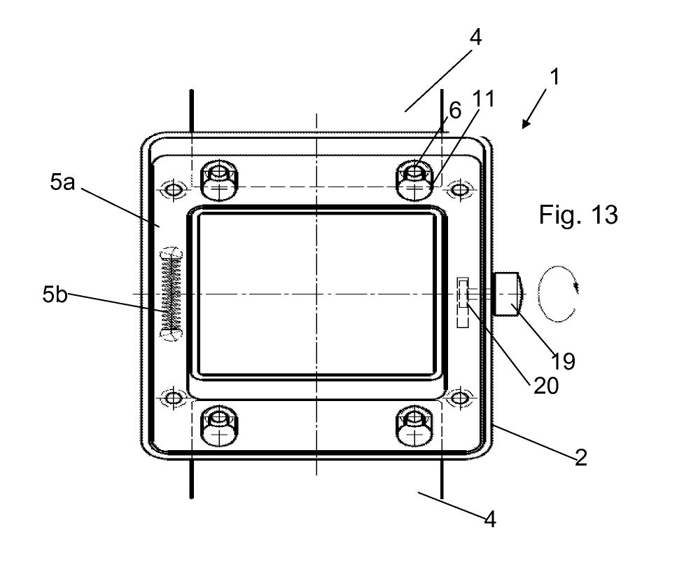

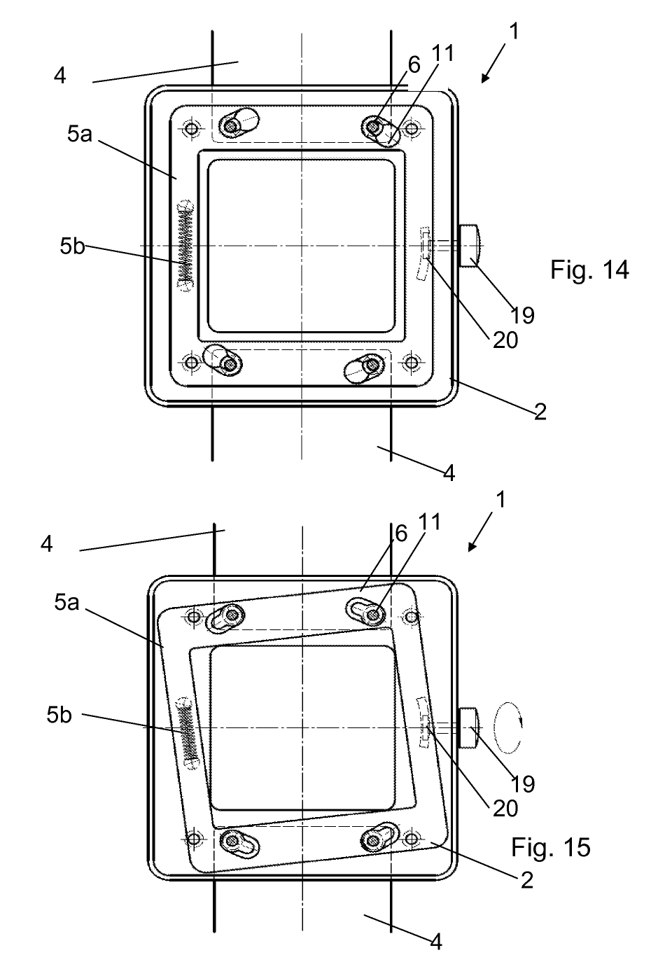

FIGS. 13, 14 and 15 also show alternatives for implementing the invention in a shaped, i.e., non-circular, case. In FIG. 13, the manual control device is a crown and the locking organ is a rectangular clamp 5a that can be translated by rotating the crown 19. In FIGS. 14 and 15, the manual control device is a crown and the locking organ is rotatable. The locking organ is in the active position in FIG. 14 and the inactive position in FIG. 15. The kinematic link between the crown 19 and the clamp 5a is similar to that previously described.

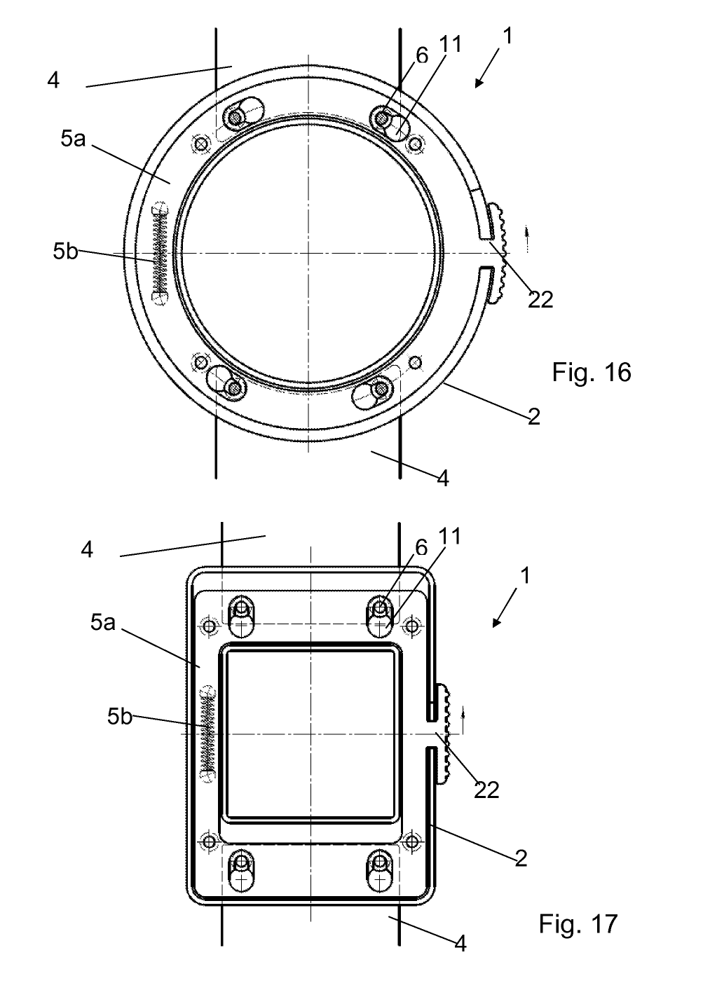

FIGS. 16 and 17 illustrate example embodiments of the invention, in which the clamp 5a is driven by the sliding of a bolt 22. In FIG. 16, the clamp 5a is annular and rotatable. In FIG. 16, the clamp 5a is rectangular and translatable. The bolt 22 can be mounted secured to the clamp.

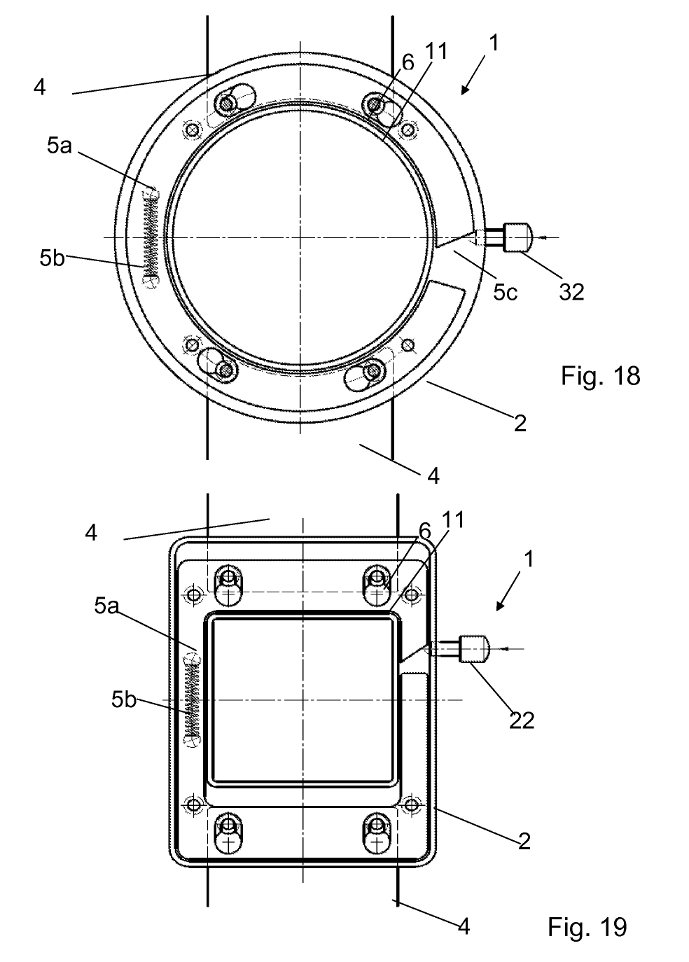

FIGS. 18 and 19 illustrate example embodiments of the invention, in which the clamp 5a is driven by actuating a push-piece, like the embodiment of FIG. 1. In FIG. 18, the clamp 5a is annular and rotatable. In FIG. 19, the clamp 5a is rectangular and translatable. The push-piece 24 is arranged to cooperate with an inclined plane 5c comprised by the clamp 5a.

The present invention also relates to a method for removing removable accessories 3, 4 from a timepiece 1, equipped with a locking organ manually movable between an active position and an inactive position to separate said accessories 3, 4 from the timepiece 1.

According to a first step, the method consists of manually moving the locking organ into its inactive position to unlock the first accessory 3 mounted on the timepiece 1.

According to a second step, the method consists of automatically moving the first accessory 3 in a removal direction from timepiece 1, over an initial removal travel to reach an intermediate removal position. In this intermediate position:
the position of the first accessory 3 is stabilized by safety means,
the first accessory 3 may be manually grasped to be completely removed,
the second accessory 4 is kept secured to the timepiece 1 by the first accessory 3.

In a third step, the first accessory 3 is moved manually so as to completely remove it and free the second accessory from the timepiece 1.

The present invention also relates to a method for replacing accessories of the timepiece 1. The accessory replacement method according to the invention consists, after carrying out the aforementioned steps, of securing the accessories 3 and 4 of the timepiece 1 by:
manually positioning the locking organ in its inactive position,
engaging at least one second accessory 4 in the timepiece 1,
engaging the first accessory 3 in the timepiece 1 in the direction opposite the removal direction, by blocking the second accessory 4 in the timepiece 1, and
automatically moving the locking organ into its active position.

The locking is therefore done automatically once the first accessory 3 is engaged in the timepiece 1 and the user releases the control of the locking organ.

It appears advantageous to give a conical shape to the collar 8 as well as the positioning hole 11, so as to facilitate the passage of the collar 8 through the locking organ and consequently facilitate the engagement of the arbor 6 in the case 2.

In one additional alternative that is not shown, the securing means are automatically activated, independently of the fact that the user has released the manual control device. This may in particular be useful if the control device is actuated in an untimely manner.

Such a system may for example be done with a manual control organ in the form of a bolt, by adapting a so-called “all or nothing” system, similar to what is found in the manual release systems of repeater watches. In this case, the bolt is not secured to the locking organ, but it comprises a hook pivotably mounted on the bolt, kept engaged on a post fixed on the clamp 5a by a spring. The hook and the spring are arranged such that the hook disengages from the post when the locking organ has reached an extreme position, beyond the inactive position. It is possible to provide a small notch in the movement of the control organ, to mark the inactive position. The locking organ may then automatically, under the action of the complementary elastic organ 5b, perform the braking function. Owing to the pivoting of the hook, it may return to its initial position. An independent return spring is positioned on the manual control device. To engage the second accessory 4, the user may bring the locking organ into the inactive position, given that the hook only disengages beyond that position.

The present description is of course not limited to the examples explicitly described, but also comprises other embodiments and/or implementations. Thus, a described technical feature or implementation step may be replaced by an equivalent technical feature or equivalent step, respectively, without going beyond the scope of the present invention.

1-21. (canceled)

22. A method for removing a first and at least one second removable accessory from a timepiece equipped with a locking organ that is manually movable between an active position and an inactive position and vice versa, the first and second accessories respectively being secured with and locked on said timepiece when the locking system is activated, and unlocked and able to be separated from said timepiece when the locking system is deactivated,
said method comprising the steps of:
manually moving the locking organ into its inactive position to unlock the first accessory mounted on the timepiece,
automatically moving the first accessory in a removal direction from the timepiece, over an initial removal travel to reach an intermediate removal position, in which:
the position of the first accessory is stabilized using securing means,
the first accessory can be grasped manually to be completely removed,
the second accessory is kept secured to the timepiece by the first accessory,
manually moving the first accessory so as to completely remove it and free the second accessory from the timepiece.

23. The method of claim 22, wherein the automatic movement of the first accessory is done by a piston cooperating with the first accessory and subject to the action of an elastic organ.

24. The method of claim 23, wherein the intermediate removal position is defined by an abutment of the piston.

25. The method of claim 22, wherein the position of the first accessory is stabilized by the securing means through braking of a functional part of the first accessory.

26. A method for replacing accessories of a timepiece consisting, after a removal according to the method of claim 22, of securing the accessories to said timepiece (1), said methods comprising the steps of:
manually positioning the locking organ in its inactive position,
engaging at least one second accessory in the timepiece,
engaging the first accessory in the timepiece in the direction opposite the removal direction by blocking said at least one second accessory in the timepiece, and
automatically moving the locking organ into its active position.

27. The method according to claim 22, wherein the locking system is moved manually by a control device and in that the securing means are activated when the control device is released.

28. The method according to claim 22, wherein the first accessory is a bezel of a case receiving the timepiece and wherein the second accessory is a bracelet.

29. A timepiece equipped with a first accessory and at least one second accessory that are removable, including a locking system that can be activated to secure and lock the accessories to the timepiece and that can be deactivated to unlock the accessories and allow them to be separated from the timepiece, the locking system including a locking organ movable between an active position and an inactive position to respectively lock and unlock the first accessory,
wherein the first accessory includes a functional part arranged to cooperate with the second accessory to secure it and lock it to the timepiece, by locking the first accessory using the locking organ, said timepiece including securing means cooperating with said functional part so as, when the locking system is deactivated, to keep the first accessory in an intermediate removal position in which said functional part keeps the second accessory secured to the timepiece.

30. The timepiece of claim 29, wherein the locking organ is arranged to cooperate with said functional part to ensure locking of the first accessory.

31. The timepiece of claim 29, including automatic expulsion means exerting a force on the first accessory tending to remove it from said timepiece.

32. The timepiece of claim 31, including an organ for limiting the travel of the automatic expulsion means, defining the intermediate removal position, in which:
the position of the first accessory is stabilized by the securing means,
the first accessory can be grasped manually to be completely removed,
the second accessory is kept secured to the timepiece by the first accessory.

33. The timepiece of claim 32, wherein the locking organ is further arranged to cooperate with said functional part to define said securing means.

34. The timepiece according to claim 29, wherein the locking organ comprises a clamp mounted movably and provided with at least one window for passage of the functional part.

35. The timepiece according to claim 29, wherein the first accessory is a bezel of a case receiving the timepiece and wherein the functional part includes at least one rod extending substantially orthogonally relative to the extension plane of the bezel.

36. The timepiece according to claim 34, wherein the arbor includes a collar, and wherein said window is dimensioned so as to define a banking with which said collar can cooperate when the locking system is in the active position, and so as to allow the free passage of the collar when the locking system is in the inactive position.

37. The timepiece according to claim 35, wherein the arbor includes a collar, and wherein said window is dimensioned so as to define a banking with which said collar can cooperate when the locking system is in the active position, and so as to allow the free passage of the collar when the locking system is in the inactive position.

38. The timepiece of claim 36, wherein said window comprises a first portion dimensioned so as to define a banking with which said collar can cooperate, the clamp being positioned such that said first portion is situated across from the collar when the locking system is in the active position, and
wherein said second portion allows the free passage of the collar, the clamp being positioned such that said second portion is situated across from the collar when the locking system is in the inactive position.

39. The timepiece of claim 37, wherein said window comprises a first portion dimensioned so as to define a banking with which said collar can cooperate, the clamp being positioned such that said first portion is situated across from the collar when the locking system is in the active position, and
wherein said second portion allows the free passage of the collar, the clamp being positioned such that said second portion is situated across from the collar when the locking system is in the inactive position.

40. The timepiece of claim 33, wherein the clamp is arranged to cooperate with the arbor to define said securing means by producing a braking force exerted on the arbor and opposing the movement to remove the bezel from said timepiece.

41. The timepiece according to claim 33, wherein the locking system further comprises a manual control device and a complementary elastic organ, said complementary elastic organ being arranged so as to participate both in the locking of the first accessory and the securing means.

42. The timepiece of claim 41, wherein the manual control device is chosen from among a crown mounted rotatably, a bolt slidingly mounted on the periphery of the timepiece, and a push-piece mounted transversely sliding in reference to the timepiece.

43. The timepiece according to claim 29, housed in a round or shaped case.

44. The timepiece according to claim 29, equipped with a second and third accessory forming the two strands of a bracelet.
